(19) United States
(12) Patent Application Publication
(10) Pub. No.: US 2026/0020620 A1
(43) Pub. Date: Jan. 22, 2026

(54) AEROSOL GENERATING DEVICE COMPRISING LIGHT EMITTING DEVICE AND OPERATING METHOD THEREFOR

(71) Applicant: KT&G CORPORATION, Daejeon (KR)

(72) Inventors: Young Bum KWON, Gyeonggi-do (KR); Dong Sung KIM, Seoul (KR); Yong Hwan KIM, Gyeonggi-do (KR); Hun Il KIM, Seoul (KR)

(73) Assignee: KT&G CORPORATION, Daejeon (KR)

(21) Appl. No.: 18/994,583

(22) PCT Filed: Dec. 21, 2023
(86) PCT No.: PCT/KR2023/021317

§ 371 Date: Jan. 14, 2025

(30) Foreign Application Priority Data
Dec. 30, 2022 (KR) 10-2022-0191112
Mar. 14, 2023 (KR) 10-2023-0033462

(51) Int. Cl. A24F 40/60; A24F 40/51; A24F 40/53; A24F 40/65; A24F 40/90; F21V 33/00

(52) U.S. Cl. CPC A24F 40/60; A24F 40/51; A24F 40/53; A24F 40/65; A24F 40/90; F21V 33/0068

(57) ABSTRACT

According to an embodiment, an aerosol generating device includes a housing including an accommodation space for accommodating an aerosol generating article, a light-emitting device for emitting light through a single light source in the housing, and a processor configured to receive a detection input of an event, determine a control mode of power supply to the single light source of the light-emitting device, based on the detection input of the event, and supply power to the single light source according to a first control mode based on the detection input of the event corresponding to a first event, and supply power to the single light source according to a second control mode based on the detection input of the event corresponding to a second event that is distinguished from the first event.

### TECHNICAL FIELD

The present disclosure relates to an aerosol generating device and an operating method of the same, and more particularly, to an aerosol generating device for outputting various pieces of state information through light-emitting devices.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

An aerosol generating device may include a component for displaying the status of a device to a user. For example, the aerosol generating device may output the device state by controlling a display-type component, such as an organic light-emitting diode (OLED) or a liquid crystal display (LCD), or respectively controlling light-emitting diodes (LED).

Recently, there has been a trend towards reducing the sizes and weights of aerosol generating devices to improve the portability for a user.

### DISCLOSURE OF INVENTION

### Technical Problem

When an aerosol generating device includes a display-type component or a plurality of light-emitting diodes, the material cost of the device and the number of components that should be arranged in a limited space in the device increase, and thus, such a device may fail to meet the trend of miniaturization and weight reduction.

One or more embodiments provide an aerosol generating device capable of displaying various pieces of information for a user through a light-emitting device with a single light source by differently setting a control mode in which power is supplied to the light-emitting device according to a detection input of an event.

The technical problems of the disclosure are not limited to the aforementioned description and technical problems that are not stated may be clearly understood by one of ordinary skill in the art from the embodiments described hereinafter and the attached drawings.

### Solution to Problem

According to one or more embodiments, an aerosol generating device includes a housing including an accommodation space configured to accommodate an aerosol generating article, a light-emitting device arranged in the housing and configured to emit light through a single light source, and a processor configured to receive a detection input of an event, determine a control mode of power supply to the single light source of the light-emitting device, based on the received detection input of the event, and supply power to the single light source according to a first control mode based on the detection input of the event corresponding to a first event, and supply power to the single light source according to a second control mode based on the detection input of the event corresponding to a second event that is distinguished from the first event.

According to one or more embodiments, an operating method of an aerosol generating device includes receiving a detection input of an event, determining a control mode of power supply to a single light source of a light-emitting device, based on the received detection input of the event, supplying power to the single light source according to a first control mode based on the detection input of the event corresponding to a first event, and supplying power to the single light source according to a second control mode based on the detection input of the event corresponding to a second event distinguished from the first event.

### Advantageous Effects of Invention

According to one or more embodiments, an aerosol generating device may provide visual information allowing users to clearly identify the emission form visually by differently controlling light emission of a light-emitting device including a single light source, according to the type of the detected event. Also, by employing a light-emitting device including a single light source, aspects associated with the cost of manufacturing aerosol generating devices and the efficiency of manufacturing processes may be improved.

Effects of the embodiments are not limited to those stated above, and effects that are not described herein may be clearly understood by one of ordinary skill in the art from the present specification and the attached drawings.

### BRIEF DESCRIPTION OF DRAWINGS

FIG. 1 is a perspective view of an aerosol generating device according to an embodiment.

FIG. 2 is a block diagram of an aerosol generating device according to an embodiment.

FIG. 3 is a flowchart illustrating a method for controlling power supplied to a light-emitting device of an aerosol generating device, according to an embodiment.

FIG. 4 illustrates an example of an aerosol generating device in which power supply is controlled according to a first control mode, according to an embodiment.

FIG. 5A illustrates an example of power supply according to the first control mode of FIG. 4.

FIG. 5B illustrates another example of power supply according to the first control mode of FIG. 4.

FIG. 5C illustrates another example of power supply according to the first control mode of FIG. 4.

FIG. 6 illustrates an example of an aerosol generating device in which power supply is controlled according to a second control mode, according to an embodiment.

FIG. 7 illustrates an example of power supply according to the second control mode of FIG. 6.

FIG. 8 is a flowchart illustrating a method for controlling power supplied to a light-emitting device an aerosol generating device, according to another embodiment.

FIG. 9 illustrates an example of aerosol generating device in which power supply is controlled according to a third control mode, according to an embodiment.

FIG. 10 illustrates an example of an aerosol generating device in which a type of an inserted aerosol generating article is displayed according to different control modes, according to an embodiment.

FIG. 11 illustrates an example of an aerosol generating device in which power supply is controlled based on a connection with an external device, according to an embodiment.

FIG. 12 is a block diagram of an aerosol generating device according to another embodiment.

### BEST MODE FOR CARRYING OUT THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating clement, a plate-shaped heating element, a needle-shaped heating clement, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

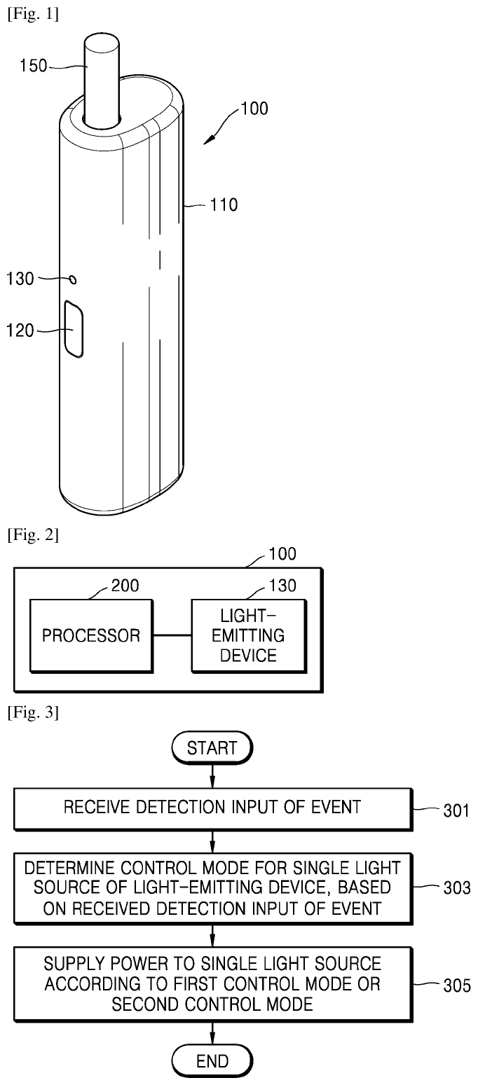

FIG. 1 is a perspective view of an aerosol generating device according to an embodiment.

Referring to FIG. 1, the aerosol generating device 100 may include a housing 110 into which an aerosol generating article 150 may be inserted, a physical button 120, and a light-emitting device 130.

In an embodiment, the housing 110 may form a general exterior of the aerosol generating device 100 and include an inner space (or ‘an arrangement space’) in which components of the aerosol generating device 100 may be arranged. FIG. 1 shows that the cross-sectional shape of the housing 110 is an oval, but the shape of the housing 110 is not limited thereto. According to an embodiment (not shown), the shape of the housing 110 may generally be a polyprism (e.g., a triangular prism or a rectangular prism), or the cross-sectional shape of the housing 110 may generally be a semicircle.

According to an embodiment, on a portion of the exterior of the housing 110, the physical button 120 that may be manipulated by the user and the light-emitting device 130 for displaying state information of the aerosol generating device 100 may be arranged. In more detail, the light-emitting device 130 may display the state information of the aerosol generating device 100 through a single light source, which is described in detail below.

FIG. 2 is a block diagram of an aerosol generating device according to an embodiment.

Referring to FIG. 2, the aerosol-generating device 100 may include the light-emitting device 130 and a processor 200. Components of the aerosol generating device 100 are not limited thereto, and according to an embodiment, other components may be added thereto or at least one component may be omitted.

In an embodiment, the light-emitting device 130 may include a single light source (e.g., one light-emitting diode (LED)) and a light guide panel (LGP). For example, based on power supplied from a battery (not shown) of the aerosol generating device 100, the light-emitting device 130 may display the state information of the aerosol generating device 100 through the single light source. Because the light-emitting device 130 emits light through the single light source, such as one LED, and the light emitted from the single light source may be substantially evenly distributed through the LGP (not shown), the amount of power consumed to display the state information of the aerosol generating device 100 may be reduced.

In an embodiment, the processor 200 may receive a detection input of an event and determine a control mode of power supply to the light-emitting device 130. In the present specification, a ‘detection input of an event’ may refer to an input signal that indicates a state change in the aerosol generating device 100. The state change may be caused by various events, and the detection input of an event may be generated upon detection of the event.

Examples of an events that trigger ‘a detection input of an event’ may include, but are not limited to, insertion or movement of an aerosol generating article (e.g., the aerosol generating article 150 of FIG. 1), errors in the aerosol generating device, a user's puff for the aerosol generating article 150, initiation of a preheating operation, a communication connection with an external device, a separate user input, and the like.

In an embodiment, when a detection input of a first event is received, the processor 200 may supply power to the light-emitting device 130 according to a first control mode. In the present specification, the expression ‘a detection input of a first event’ may refer to a detection input of an event in which the state change in the aerosol generating device 100 may be output as ‘0’ or ‘1,’ and the ‘first control mode’ may refer to a control mode in which supply and interruption of power to the single light source of the light-emitting device 130 are repeated for a preset period of time. The ‘first control mode’ may include all control methods in which supply and interruption of power are repeated for a preset period of time. That is, according to the type of the detection input (e.g., detection of insertion, movement, and errors in an aerosol generating article, etc.), the number of power supplies, a power supply cycle, and time, etc. in the ‘first control mode’ may differ.

For example, when the aerosol generating device 100 outputs information regarding the insertion of the aerosol generating article 150, the aerosol generating device 100 may output ‘1’ when the aerosol generating article 150 is inserted and output ‘0’ when the aerosol generating article 150 is not inserted. Thus, the insertion of the aerosol generating article 150 may trigger the ‘detection input of the first event.’

As another example, when the aerosol generating device 100 outputs information regarding the movement (or removal) of the aerosol generating article 150, the aerosol generating device 100 may output ‘1’ when the aerosol generating article 150 is moved (or removed) and ‘0’ when the aerosol generating article 150 is not moved. Thus, the movement of the aerosol generating article 150 may trigger the ‘detection input of the first event.’

As another example, when the aerosol generating device 100 outputs information regarding the occurrence of errors in the aerosol generating device 100, the aerosol generating device 100 may output ‘1’ when a temperature of a heater of the aerosol generating device 100 abruptly rises above a threshold, and output ‘0’ when the temperature is lower than the threshold value. Thus, the occurrence of errors in the aerosol generating device 100 may trigger the ‘detection input of the first event.’

In an embodiment, the processor 200 may control the light-emitting device 130 by varying the number and duration of the first control mode, according to the type of a detection input of the first event. For example, when the aerosol generating article 150 is inserted, supply and interruption of the power may be repeated once for a second. Also, when the aerosol generating article 150 is moved, the supply and interruption of the power may be repeated three times for three seconds. However, this is merely an example for convenience of explanation, and detailed descriptions are provided below.

In an embodiment, when a detection input of a second event is received, the processor 200 may supply power to the light-emitting device 130 according to a second control mode. In the present specification, the ‘detection input of the second event’ may refer to a detection input of an event in which a state change in the aerosol generating device 100 may be output as a series of values (i.e., a binary number cannot represent the state change according to a second event), and the ‘second control mode’ may refer to a control mode in which power supply to the single light source of the light-emitting device 130 is adjusted within a preset range.

For example, when the aerosol generating device 100 outputs information regarding the number of remaining puffs for the aerosol generating article 150 inserted thereinto, the number of remaining puffs may be obtained by subtracting one from the initial number of available puffs (e.g., 14 times) whenever the user's puff is detected. Thus, the number of remaining puffs for the aerosol generating article 150 may correspond to the detection input of the second event.

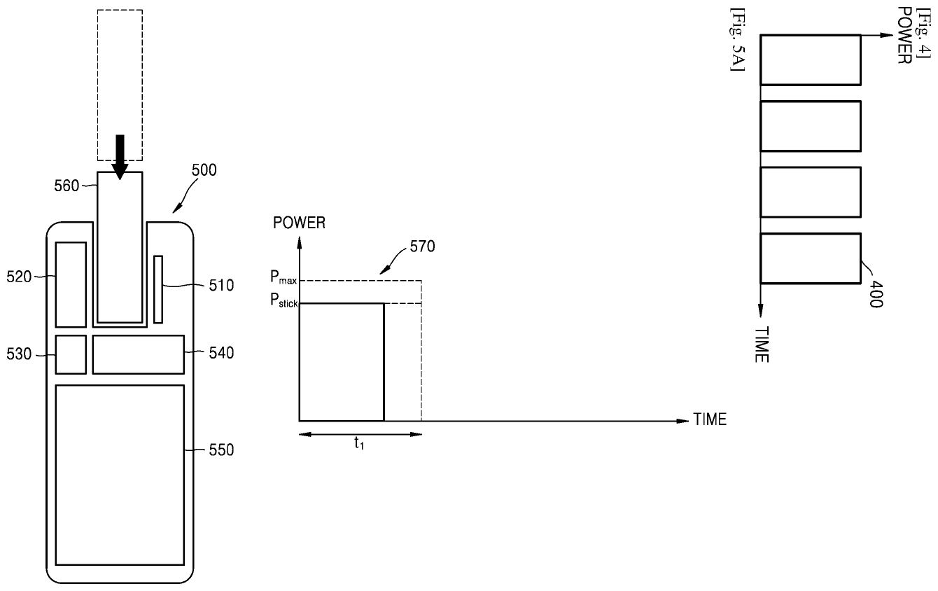

FIG. 3 is a flowchart illustrating a method for controlling power supplied to a light-emitting device of an aerosol generating device, according to an embodiment.

Referring to FIG. 3, in operation 301, a processor (e.g., the processor 200 of FIG. 2) of an aerosol generating device (e.g., the aerosol generating device 100 of FIG. 1) may receive a detection input of an event.

In an embodiment, the aerosol generating device 100 may further include components configured to detect various events and generate detection inputs of the events.

For example, the aerosol generating device 100 may further include an insertion detection sensor for sensing the insertion and/or movement of the aerosol generating article (e.g., the aerosol generating article 150 of FIG. 1). As another example, the aerosol generating device 100 may further include a sensor (e.g., a temperature sensor for measuring a temperature of a heater) that may detect errors of the aerosol generating device 100. As another example, the aerosol generating device 100 may further include a puff sensor capable of detecting the user's puff for the aerosol generating article 150. However, components that may be included in the aerosol generating device 100 are not limited thereto, and various components may be added according to a design change by a manufacturer.

According to an embodiment, the processor 200 may determine a control mode of the power supply to the single light source of the light-emitting device (e.g., the light-emitting device 130 of FIG. 1) in response to the detection input of the event that is received in operation 303.

In an embodiment, when the detection input of the first event is received, the processor 200 may determine to provide power to the light-emitting device 130 according to the first control mode. In this case, the ‘detection input of the first event’ may refer to a detection input of the event in which the state change in the aerosol generating device 100 may be output as ‘0’ or ‘1,’ and ‘the first control mode’ may refer to a control mode in which supply and interruption of power to the single light source of the light-emitting device 130 are repeated for a preset period of time. That is, ‘the first control mode’ may refer to a control mode in which the single light source of the light-emitting device 130 blinks and may be referred to as a flickering control mode (or a blinking control mode).

In the present embodiment, as the detection input of the first event is received, the control mode is determined as the first control mode in which the single light source of the light-emitting device 130 blinks, and thus, the state change in the aerosol generating device 100 may be clearly identified visually. That is, in the case of the detection input of the first event that merely indicates whether or not the state change has occurred in the aerosol generating device 100, dimming control for controlling in stages the brightness of the light-emitting device 130 is unnecessary, and the information associated with the state change in the aerosol generating device 100 may be output simply by flickering of the light-emitting device 130.

On the other hand, when the detection input of the second event is received, the processor 200 may determine to supply power to the light-emitting device 130 according to the second control mode. In this case, the ‘detection input of the second event’ may refer to a detection input of an event in which the state change in the aerosol generating device 100 may be output as a series of values, and the ‘second control mode’ may refer to a control mode in which power supplied to the single light source of the light-emitting device 130 is adjusted within the preset range. That is, the ‘second control mode’ may refer to a control mode in which the brightness of the single light source of the light-emitting device 130 is adjusted in stages. The second control mode may be referred to as a dimming control mode.

In the present embodiment, as the detection input of the second event is received, the control mode is determined as the second control mode in which the brightness of the single light source of the light-emitting device 130 is adjusted in stages, and thus, the degree of the state change in the aerosol generating device 100 may be clearly identified visually. That is, in the case of the detection input of the second event, the information associated with the degree of the state change in the aerosol generating device 100 may be output based on dimming control for controlling in stages the brightness of the single light source of the light-emitting device 130.

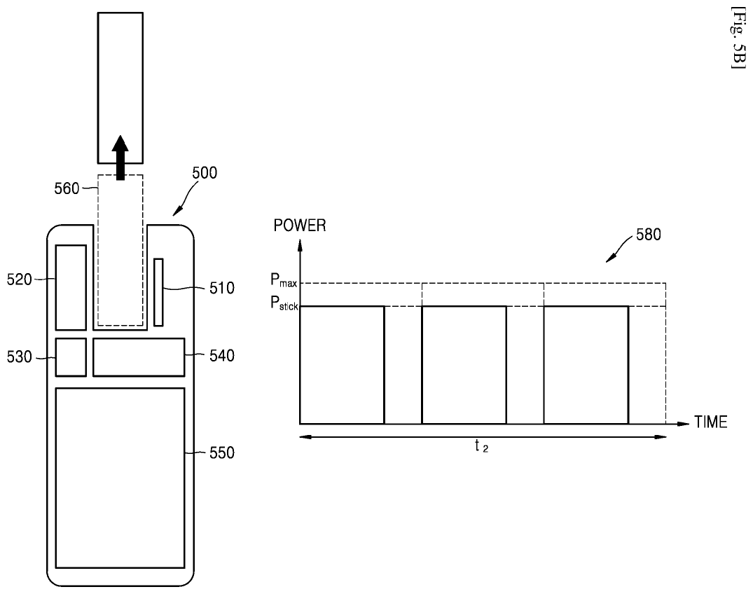

According to an embodiment, in operation 305, the processor 200 may supply power to the single light source of the light-emitting device 130 according to the first control mode or the second control mode. Detailed descriptions regarding the power supply by the processor 200 according to the first control mode or the second control mode are provided below with reference to FIGS. 4 to 9.

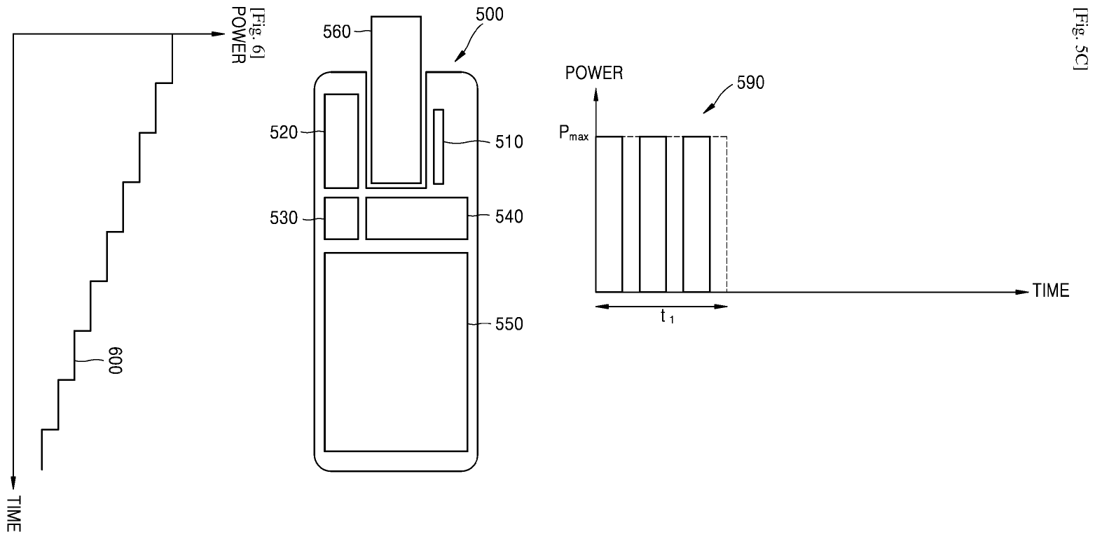

FIG. 4 illustrates an example of an aerosol generating device in which power supply is controlled according to a first control mode, according to an embodiment. FIG. 5A illustrates an example of power supply according to the first control mode of FIG. 4. FIG. 5B illustrates another example of power supply according to the first control mode of FIG. 4. FIG. 5C illustrates another example of power supply according to the first control mode of FIG. 4.

Referring to FIG. 4, when the control mode for the single light source of the light-emitting device (e.g., the light-emitting device 130 of FIG. 2) is determined as the ‘first control mode’ in operation 303 of FIG. 3, the processor (e.g., the processor 200 of FIG. 2) of the aerosol generating device (e.g., the aerosol generating device 100 of FIG. 1) may supply power to the light-emitting device 130, based on a first graph 400. As shown in FIG. 4, the first graph 400 may indicate a power supply profile in which power interruption is repeated after power supply is maintained for a certain period of time.

Referring to FIGS. 5A to 5C, an aerosol generating device 500 may include an insertion detection sensor 510 for detecting insertion of an aerosol generating article 560, a heater 520, a light-emitting device 530, a processor 540, and a battery 550. In this case, because the aerosol generating device 500 may correspond to the aerosol generating device 100 of FIG. 1, descriptions that are the same as or similar to those provided above may be omitted.

Referring to FIG. 5A, the processor 540 may receive an input upon the detection of the insertion of the aerosol generating article 560 through the insertion detection sensor 510. In this case, the insertion detection sensor 510 may include at least one of a film sensor, a pressure sensor, an optical sensor, a resistive sensor, a capacitive sensor, an inductive sensor, and an infrared sensor, and may sense a signal change according to the insertion of the aerosol generating article 560.

In an embodiment, upon reception of the detection input of an event corresponding to the insertion of the aerosol generating article 560, the processor 540 may supply power to the light-emitting device 530 through the battery 550. In this case, the processor 540 may determine a control mode of the power supply to the light-emitting device 530 as the first control mode, upon reception of the detection input of an event corresponding to the insertion of the aerosol generating article 560.

As such, the processor 540 may supply power to the light-emitting device 530 to correspond to a graph 570. For example, the processor 540 may supply first power P_{stick} to a single light source of the light-emitting device 530 and then stop the power supply, in a preset period of time t₁ (e.g., one second). In this case, the first power P_{stick} may be about 80% of the maximum power Pₘₐₓ, but is not limited thereto.

Referring to FIG. 5B, the processor 540 may receive a detection input of an event corresponding to the movement (or removal) of the aerosol generating article 560 from the insertion detection sensor 510.

In an embodiment, upon reception of the detection input of an event corresponding to the movement of the aerosol generating article 560, the processor 540 may supply power to the light-emitting device 530 through the battery 550. In this case, the processor 540 may determine a control mode of the power supply to the light-emitting device 530 to the first control mode, upon reception of the detection input of an event corresponding to the movement of the aerosol generating article 560.

In an embodiment, the processor 540 may supply power to the light-emitting device 530 to correspond to a graph 580 after determining the control mode of the power supply to the light-emitting device 530 as the first control mode. For example, the processor 540 may supply the first power P_{stick} to the single light source of the light-emitting device 530 with three interruptions, in a preset period of time t₂ (e.g., three seconds). In this case, the first power P_{stick} may be about 80% of the maximum power Pₘₐₓ, but is not limited thereto.

Referring to FIG. 5C, the processor 540 may measure a temperature of the heater 520 through a temperature sensor (not shown) and receive a detection input of an event corresponding to an error (that is, overheating). For example, the aerosol generating device 500 may include a separate temperature sensor for measuring the temperature of the heater 520, or the heater 520 may function as a temperature sensor.

In an embodiment, upon reception of a detection input of an event corresponding to an error such as overheating of the heater 520, the processor 540 may supply power to the light-emitting device 530 through the battery 550. In this case, the processor 540 may determine the control mode of the power supply to the light-emitting device 530 as the first control mode, upon reception of the detection input of an event corresponding to the error in the aerosol generating device 500.

In an embodiment, the processor 540 may supply power to the light-emitting device 530 to correspond to a graph 590 after determining the control mode of the power supply to the light-emitting device 530 as the first control mode. For example, the processor 540 may supply maximum power Pₘₐₓ to the single light source of the light-emitting device 530 with three interruptions, in a preset period of time t₁ (e.g., one second).

The present embodiment only illustrates the overheating of the heater 520 as an example of an error (i.e., an abnormal operation) of the aerosol generating device 500, but one or more embodiments are not limited thereto. In another embodiment, the processor 540 may receive various detection inputs of events (e.g., insertion of a used aerosol generating article, etc.) associated with an error of the aerosol generating device 500, and may determine the control mode of the power supply to the light-emitting device 530 as the first control mode based on the received detection inputs.

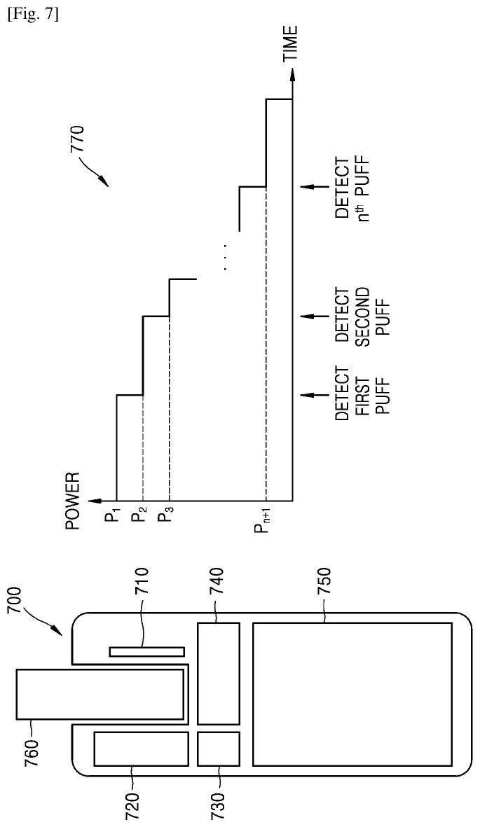

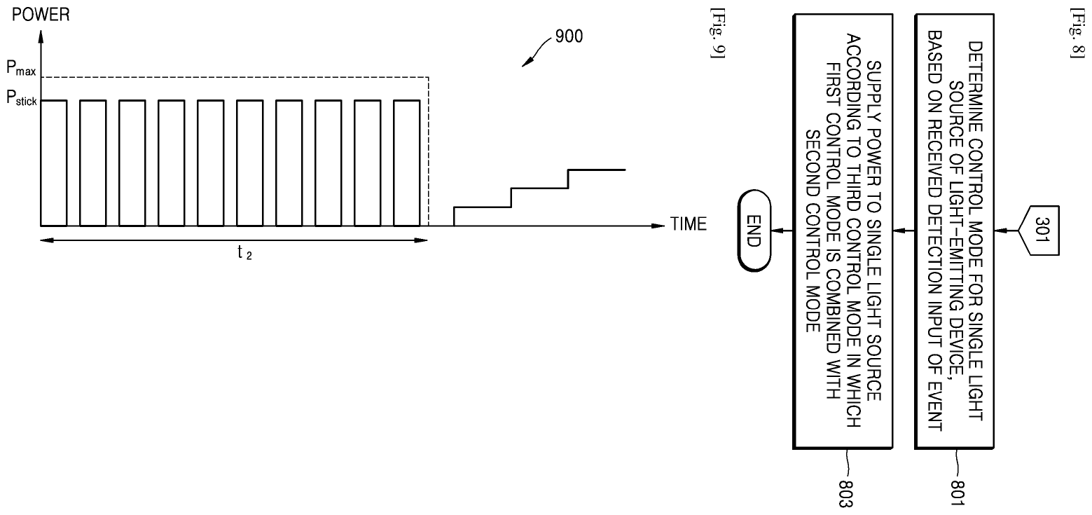

FIG. 6 illustrates an example of an aerosol generating device in which power supply is controlled according to a second control mode, according to an embodiment. FIG. 7 illustrates an example of power supply according to the second control mode of FIG. 6.

Referring to FIG. 6, when the control mode for the single light source of the light-emitting device (e.g., the light-emitting device 130 of FIG. 2) is determined as the ‘second control mode’ in operation 303 of FIG. 3, the processor (e.g., the processor 200 of FIG. 2) of the aerosol generating device (e.g., the aerosol generating device 100 of FIG. 1) may supply power to the light-emitting device 130, based on a first graph 600. That is, the second graph 600 may indicate a power supply profile in which supplied power decreases in a stepwise manner within a preset range. In this case, the expression ‘preset range’ may include a plurality of power levels corresponding to a plurality of dimming levels.

Referring to FIG. 7, an aerosol generating device 700 may include a puff sensor 710 for sensing puffs of the user, a heater 720, a light-emitting device 730, a processor 740, and a battery 750. In this case, because the aerosol generating device 700 may correspond to the aerosol generating device 100 of FIG. 1, descriptions that are the same as or similar to those provided above may be omitted.

In an embodiment, the processor 740 may receive a detection input of an event corresponding to the user's puff from the puff sensor 710. In this case, the puff sensor 710 may sense the user's puff, based on various physical changes in an airflow passage or an airflow channel. For example, the puff sensor 710 may sense the user's puff, based on any one of a temperature change, a flow change, a voltage change, and a pressure change.

In an embodiment, upon reception of the detection input of an event corresponding to the user's puff, the processor 740 may supply power to the light-emitting device 730 through the battery 750. In this case, the processor 740 may determine the control mode of the power supply to the light-emitting device 730 as the second control mode.

In an embodiment, the processor 740 may supply power to the light-emitting device 730 to correspond to a graph 770 after determining the control mode of the power supply to the light-emitting device 730 as the second control mode. For example, when the number of available puffs for the aerosol generating article 760 inserted into the aerosol generating device 700 is n times, the processor 740 may obtain a plurality of power values (P1, P2, P3, [symbol] , Pₙ₊₁) by dividing the preset power range into (n+1) power ranges. That is, the single light source of the light-emitting device 730 may include (n+1) dimming levels.

Also, the processor 740 may supply power to the light-emitting device 730 through the battery 750 at P₁ that is the greatest value among the power values. Accordingly, the single light source of the light-emitting device 730 may emit light at the brightness with the highest level (e.g., about 80%) among the dimming levels, and the user may identify, through the light-emitting device 730, that the current number of remaining puffs for the aerosol generating article 760 is at the maximum.

Then, upon reception of the detection input of an event corresponding to a first puff of the user, the processor 740 may supply power to the light-emitting device 730 through the battery 750 at P₂ that is less than P₁. Upon reception of the detection input of an event corresponding to a second puff of the user, the processor 740 may supply power to the light-emitting device 730 through the battery 750 at P₃ that is less than P₂.

FIG. 8 is a flowchart illustrating a method for controlling power supplied to a light-emitting device of an aerosol generating device, according to another embodiment. FIG. 8 illustrates subsequent operations after operation 301 of FIG. 3, and descriptions that are the same as or similar to those provided above may be omitted.

Referring to FIG. 8, the processor (e.g., the processor 200 of FIG. 2) of the aerosol generating device (e.g., the aerosol generating device 100 of FIG. 1) may determine the control mode of the power supply to the single light source of the light-emitting device (e.g., the light-emitting device 130 of FIG. 1), based on the detection input of the event that is received in operation 801.

In an embodiment, when a detection input of a third event is received, the processor 200 may determine to provide power to the light-emitting device 130 according to the third control mode. In this case, the ‘detection input of the third event’ may refer to a detection input of an event that may be output as a temporal change and/or a temperature change in the aerosol generating device 100 or in which specific information may be output. The ‘third control mode’ may refer to a control mode in which the ‘first control mode’ is combined with the ‘second control mode.’

That is, the ‘third control mode’ may refer to a control mode in which the single light source of the light-emitting device 130 is controlled to blink for a preset period of time according to the ‘first control mode’ and then the brightness of the single light source of the light-emitting device 130 is controlled according to the dimming level according to the ‘second control mode.’ However, one or more embodiments are not limited thereto, and the ‘third control mode’ may also refer to a control mode in which the single light source of the light-emitting device 130 is controlled according to the ‘first control mode’ after the ‘second control mode.’

According to an embodiment, in operation 803, the processor 200 may supply power to the single light source of the light-emitting device 130, according to the third control mode. Detailed descriptions regarding the power supply by the processor 200 according to the third control mode are provided below with reference to FIGS. 9 to 11.

FIG. 9 illustrates an example of aerosol generating device in which power supply is controlled according to a third control mode, according to an embodiment.

Referring to FIG. 9, upon reception of a detection input of an event corresponding to initiation of a preheating operation of an aerosol generating article (e.g., the aerosol generating article 150 of FIG. 1), the processor (e.g., the processor 200 of FIG. 2) may supply power to the light-emitting device 130 (e.g., the light-emitting device 130 of FIG. 2). In this case, the processor 200 may determine the control mode of the power supply to the light-emitting device 130 as the third control mode, upon reception of the detection input of an event corresponding to the initiation of the preheating operation of the aerosol generating article 150.

In an embodiment, the processor 200 may supply power to the light-emitting device 130 to correspond to a graph 900 after determining the control mode of the power supply to the light-emitting device 130 as the third control mode.

In an embodiment, the processor 200 may supply first power P_{stick} to the single light source of the light-emitting device 130 with ten interruptions, in a preset period of time t₂ (e.g., three seconds), thereby controlling the light-emitting device 130 in the first control mode. In this case, the first power P_{stick} may be about 80% of the maximum power Pₘₐₓ, but is not limited thereto.

Then, after the preset period of time t₂ has passed, the processor 200 may adjust power supplied to the light-emitting device 130 in a stepwise manner within a preset power range as smoking progresses, according to the temperature increase of the aerosol generating device 100 or the passage of time.

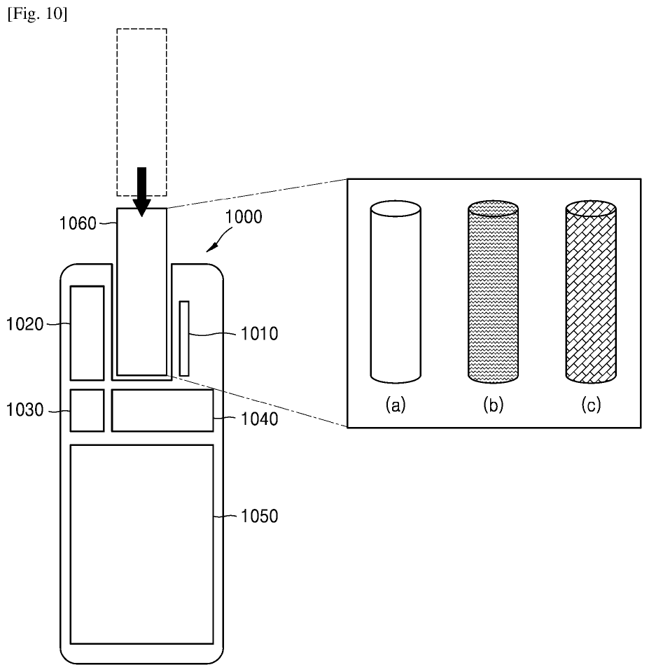

FIG. 10 illustrates an example of an aerosol generating device in which a type of an inserted aerosol generating article is displayed according to different control modes, according to an embodiment.

Referring to FIG. 10, an aerosol generating device 1000 may include a cigarette recognition sensor 1010 for identifying the type of an inserted aerosol generating article 1060, a heater 1020, a light-emitting device 1030, a processor 1040, and a battery 1050. In this case, because the aerosol generating device 1000 may correspond to the aerosol generating device 100 of FIG. 1, descriptions that are the same as or similar to those provided above may be omitted.

In an embodiment, the processor 1040 may receive a detection input of an event corresponding to identification of the type of the aerosol generating article 1060 from the cigarette recognition sensor 1010. In this case, the cigarette recognition sensor 1010 may identify the type of the aerosol generating article 1060, based on an identifying element included in the aerosol generating article 1060, an electrical feature value of the aerosol generating article 1060, and the like. For example, as the aerosol generating article 1060 is inserted, the cigarette recognition sensor 1010 may identify whether the aerosol generating article 1060 is of type a, type b, or type c.

In an embodiment, upon reception of the detection input of an event corresponding to identification of the type of the aerosol generating article 1060, the processor 1040 may supply power to the light-emitting device 1030 through the battery 1050. In this case, upon reception of the detection input of an event corresponding to identification of the type of the aerosol generating article 1060, the processor 1040 may determine the control mode of the power supply to the light-emitting device 1030 as the first control mode, the second control mode, or the third control mode.

For example, when the aerosol generating article 1060 is of type a, the processor 1040 may repeatedly perform supply and interruption of power to the light-emitting device 1030 for a preset period of time, based on the first control mode. As another example, when the aerosol generating article 1060 is of type b, the processor 1040 may adjust the supplied power to the light-emitting device 1030 within a preset range, based on the second control mode. As another example, when the aerosol generating article 1060 is of type c, the processor 1040 may repeat a power supply to the light-emitting device 1030 followed by an interruption for a preset period of time, based on the third control mode. However, this is merely an example, and a control mode according to a type of an aerosol generating article may vary according to the design of the manufacturer.

Also, in an embodiment, the processor 1040 may reset the number of available puffs according to the type of the aerosol generating article 1060 that is identified through the cigarette recognition sensor 1010, reset the number of dimming levels based on the reset number of available puffs, and control the power supply to the light-emitting device 1030 accordingly. For example, when the number of available puffs for the aerosol generating article of type a is 14 and the number of available puffs for the aerosol generating article of type b is 10, the processor 1040 may output the number of remaining puffs for type a with 15 dimming levels, and output information regarding the number of remaining puffs for type b with 11 dimming levels.

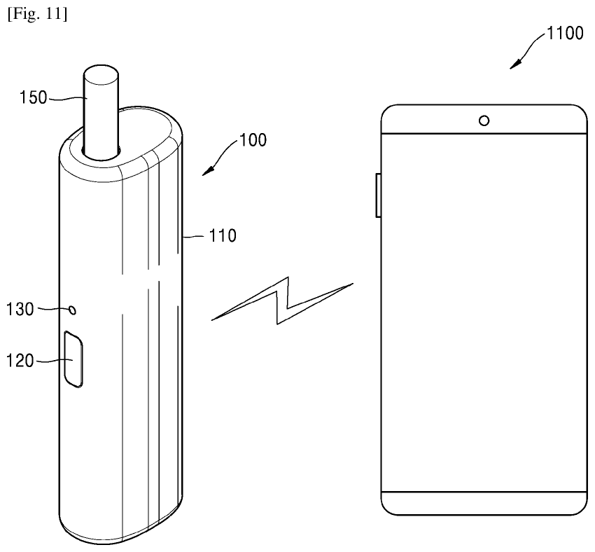

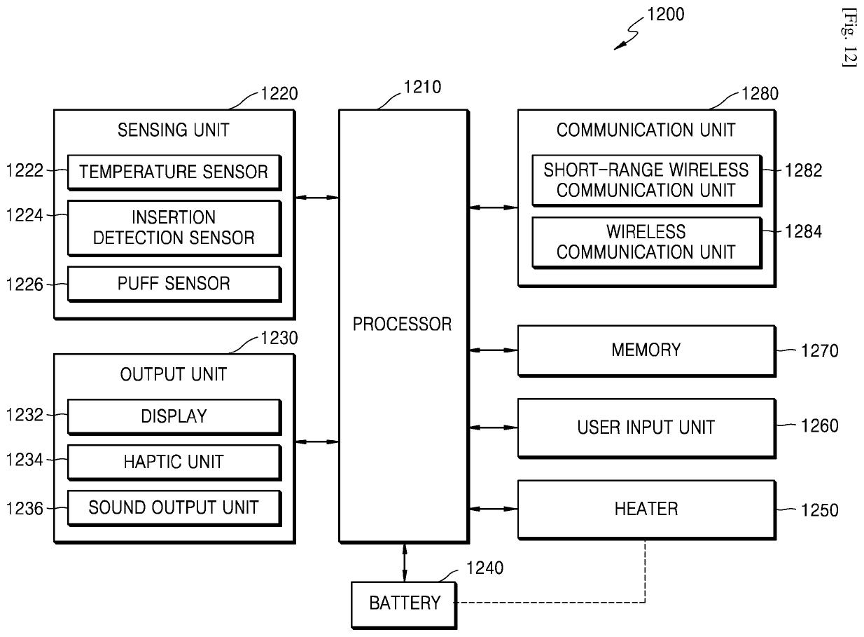

FIG. 11 illustrates an example of an aerosol generating device in which power supply is controlled according to a connection with an external device, according to an embodiment.

Referring to FIG. 11, the aerosol generating device 100 may include the housing 110 into which the aerosol generating article 140 may be inserted, the physical button 120, the light-emitting device 130, and an interface (not shown) that may be connected to the outside.

In an embodiment, the processor (e.g., the processor 200 of FIG. 2) of the aerosol generating device 100 may receive a detection input of an event associated with the interface, such as establishment of communication connection between the aerosol generating device 100 and an external device 1100, start or stop of charging, message reception, and notification information reception, etc. For example, when the aerosol generating device 100 and the external device 1100 are connected to each other via Bluetooth, the aerosol generating device 100 may receive, through the interface, a detection input upon the establishment of the communication connection.

In an embodiment, the processor 200 may control the power supply to the light-emitting device 130 based on the detection input of an event that is received through the interface. For example, as the Bluetooth connection is established between the aerosol generating device 100 and the external device 1100, the processor 200 may control the power supply to the light-emitting device 130 according to one of ‘the first control mode,’ ‘the second control mode,’ and ‘the third control mode.’

FIG. 12 is a block diagram of an aerosol generating device 1200 according to another embodiment.

The aerosol generating device 1200 may include a controller 1210, a sensing unit 1220, an output unit 1230, a battery 1240, a heater 1250, a user input unit 1260, a memory 1270, and a communication unit 1280. However, the internal structure of the aerosol generating device 1200 is not limited to those illustrated in FIG. 12. That is, according to the design of the aerosol generating device 1200, it will be understood by one of ordinary skill in the art that some of the components shown in FIG. 12 may be omitted or new components may be added.

The sensing unit 1220 may sense a state of the aerosol generating device 1200 and a state around the aerosol generating device 1200, and transmit sensed information to the controller 1210. Based on the sensed information, the controller 1210 may control the aerosol generating device 1200 to perform various functions, such as controlling an operation of the heater 1250, limiting smoking, determining whether an aerosol generating article (e.g., a cigarette, a cartridge, or the like) is inserted, displaying a notification, or the like.

The sensing unit 1220 may include at least one of a temperature sensor 1222, an insertion detection sensor, and a puff sensor 1226, but is not limited thereto.

The temperature sensor 1222 may sense a temperature at which the heater 1250 (or an aerosol generating material) is heated. The aerosol generating device 1200 may include a separate temperature sensor for sensing the temperature of the heater 1250, or the heater 1250 may serve as a temperature sensor. Alternatively, the temperature sensor 1222 may also be arranged around the battery 1240 to monitor the temperature of the battery 1240.

The insertion detection sensor 1224 may sense insertion and/or removal of an aerosol generating article. For example, the insertion detection sensor 1224 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1226 may sense a user's puff on the basis of various physical changes in an airflow passage or an airflow channel. For example, the puff sensor 1226 may sense a user's puff on the basis of any one of a temperature change, a flow change, a voltage change, and a pressure change.

The sensing unit 1220 may include, in addition to the temperature sensor 1222, the insertion detection sensor 1224, and the puff sensor 1226 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1230 may output information on a state of the aerosol generating device 1200 and provide the information to a user. The output unit 1230 may include at least one of a display unit 1232, a haptic unit 1234, and a sound output unit 1236, but is not limited thereto. When the display unit 1232 and a touch pad form a layered structure to form a touch screen, the display unit 1232 may also be used as an input device in addition to an output device.

The display unit 1232 may visually provide information about the aerosol generating device 1200 to the user. For example, information about the aerosol generating device 1200 may mean various pieces of information, such as a charging/discharging state of the battery 1240 of the aerosol generating device 1200, a preheating state of the heater 1250, an insertion/removal state of an aerosol generating article, or a state in which the use of the aerosol generating device 1200 is restricted (e.g., sensing of an abnormal object), or the like, and the display unit 1232 may output the information to the outside. The display unit 1232 may be, for example, a liquid crystal display panel (LCD), an organic light-emitting diode (OLED) display panel, or the like. In addition, the display unit 1232 may be in the form of a light-emitting diode (LED) light-emitting device.

The haptic unit 1234 may tactilely provide information about the aerosol generating device 1200 to the user by converting an electrical signal into a mechanical stimulus or an electrical stimulus. For example, the haptic unit 1234 may include a motor, a piezoelectric element, or an electrical stimulation device.

The sound output unit 1236 may audibly provide information about the aerosol generating device 1200 to the user. For example, the sound output unit 1236 may convert an electrical signal into a sound signal and output the same to the outside.

The battery 1240 may supply power used to operate the aerosol generating device 1200. The battery 1240 may supply power such that the heater 1250 may be heated. In addition, the battery 1240 may supply power required for operations of other components (e.g., the sensing unit 1220, the output unit 1230, the user input unit 1260, the memory 1270, and the communication unit 1280) in the aerosol generating device 1200. The battery 1240 may be a rechargeable battery or a disposable battery. For example, the battery 1240 may be a lithium polymer (LiPoly) battery, but is not limited thereto.

The heater 1250 may receive power from the battery 1240 to heat an aerosol generating material. Although not illustrated in FIG. 12, the aerosol generating device 1200 may further include a power conversion circuit (e.g., a direct current (DC)/DC converter) that converts power of the battery 1240 and supplies the same to the heater 1250. In addition, when the aerosol generating device 1200 generates aerosols in an induction heating method, the aerosol generating device 1200 may further include a DC/alternating current (AC) that converts DC power of the battery 1240 into AC power.

The controller 1210, the sensing unit 1220, the output unit 1230, the user input unit 1260, the memory 1270, and the communication unit 1280 may each receive power from the battery 1240 to perform a function. Although not illustrated in FIG. 12, the aerosol generating device 1200 may further include a power conversion circuit that converts power of the battery 1240 to supply the power to respective components, for example, a low dropout (LDO) circuit, or a voltage regulator circuit.

In an embodiment, the heater 1250 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1250 may be implemented by a metal wire, a metal plate on which an electrically conductive track is arranged, a ceramic heating element, or the like, but is not limited thereto.

In another embodiment, the heater 1250 may be a heater of an induction heating type. For example, the heater 1250 may include a susceptor that heats an aerosol generating material by generating heat through a magnetic field applied by a coil.

The user input unit 1260 may receive information input from the user or may output information to the user. For example, the user input unit 1260 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 12, the aerosol generating device 1200 may further include a connection interface, such as a universal serial bus (USB) interface, and may connect to other external devices through the connection interface, such as the USB interface, to transmit and receive information, or to charge the battery 1240.

The memory 1270 is a hardware component that stores various types of data processed in the aerosol generating device 1200, and may store data processed and data to be processed by the controller 1210. The memory 1270 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1270 may store an operation time of the aerosol generating device 1200, the maximum number of puffs, the current number of puffs, at least one temperature profile, data on a user's smoking pattern, etc.

The communication unit 1280 may include at least one component for communication with another electronic device. For example, the communication unit 1280 may include a short-range wireless communication unit 1282 and a wireless communication unit 1284.

The short-range wireless communication unit 1282 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1284 may include a cellular network communication unit, an Internet communication unit, a computer network (e.g., local area network (LAN) or wide area network (WAN)) communication unit, or the like, but is not limited thereto. The wireless communication unit 1284 may also identify and authenticate the aerosol generating device 1200 within a communication network by using subscriber information (e.g., International Mobile Subscriber Identifier (IMSI)).

The controller 1210 may control general operations of the aerosol generating device 1200. In an embodiment, the controller 1210 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1210 may control the temperature of the heater 1250 by controlling supply of power of the battery 1240 to the heater 1250. For example, the controller 1210 may control power supply by controlling switching of a switching element between the battery 1240 and the heater 1250. In another example, a direct heating circuit may also control power supply to the heater 1250 according to a control command of the controller 1210.

The controller 1210 may analyze a result sensed by the sensing unit 1220 and control subsequent processes to be performed. For example, the controller 1210 may control power supplied to the heater 1250 to start or end an operation of the heater 1250 on the basis of a result sensed by the sensing unit 1220. As another example, the controller 1210 may control, based on a result sensed by the sensing unit 1220, an amount of power supplied to the heater 1250 and the time the power is supplied, such that the heater 1250 may be heated to a certain temperature or maintained at an appropriate temperature.

The controller 1210 may control the output unit 1230 on the basis of a result sensed by the sensing unit 1220. For example, when the number of puffs counted through the puff sensor 1226 reaches a preset number, the controller 1210 may notify the user that the aerosol generating device 1200 will soon be terminated through at least one of the display unit 1232, the haptic unit 1234, and the sound output unit 1236.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a housing comprising an accommodation space configured to accommodate an aerosol generating article;
a light-emitting device arranged in the housing and configured to emit light through a single light source; and
a processor configured to:
receive a detection input of an event;
determine a control mode of power supply to the single light source of the light-emitting device, based on the received detection input of the event; and
supply power to the single light source according to a first control mode based on the detection input of the event corresponding to a first event, and supply power to the single light source according to a second control mode based on the detection input of the event corresponding to a second event that is distinguished from the first event.

2. The aerosol generating device of claim 1, wherein the processor is further configured to repeat supply and interruption of power to the single light source for a preset period of time according to the first control mode.

3. The aerosol generating device of claim 2, wherein the processor is further configured to set maximum power supplied to the single light source and repeat the supply and interruption of power with the set maximum power.

4. The aerosol generating device of claim 1, wherein the processor is further configured to adjust the power supplied to the single light source within a preset range according to the second control mode. The aerosol generating device of claim 4, wherein

5. the preset range comprises a plurality of power levels respectively corresponding to a plurality of dimming levels, and the processor is further configured to adjust the power supplied to the single light source according to one of the dimming levels based on the second event.

6. The aerosol generating device of claim 1, wherein the first event is one of insertion of the aerosol generating article detected by an insertion detection sensor, movement of the aerosol generating article, and detection of an error in the aerosol generating device.

7. The aerosol generating device of claim 1, wherein the second event is a user's puff detected by a puff sensor.

8. The aerosol generating device of claim 1, wherein the processor is further configured to receive a detection input of a third event that is distinguished from the first event and the second event, and supply power to the single light source of the light-emitting device according to a third control mode, and
the third control mode is a control mode in which the first control mode is combined with the second control mode.

9. The aerosol generating device of claim 8, wherein the third event is start of preheating of the aerosol generating article or identification of a type of the aerosol generating article.

10. The aerosol generating device of claim 8, further comprising an interface capable of being connected to an outside,
wherein the third event is one of establishment of a communication connection between the aerosol generating device and an external device, start or stop of charging, message reception, and reception of notification information, and
wherein the third event is detected through the interface.

11. An operating method of an aerosol generating device, the operating method comprising:
receiving a detection input of an event;
determining a control mode of power supply to a single light source of a light-emitting device, based on the received detection input of the event; and
supplying power to the single light source according to a first control mode based on the detection input of the event corresponding to a first event, and supplying power to the single light source according to a second control mode based on the detection input of the event corresponding to a second event distinguished from the first event.

12. The operating method of claim 11, wherein the supplying of the power according to the first control mode comprises repeating supply and interruption of power to the single light source for a preset period of time.

13. The operating method of claim 11, wherein the supplying of the power according to the second control mode comprises adjusting the power supplied to the single light source within a preset range.

14. The operating method of claim 13, wherein the preset range comprises a plurality of power levels respectively corresponding to a plurality of dimming levels, and
the power supplied to the single light source is adjusted according to one of the dimming levels based on the second event.

15. The operating method of claim 11, further comprising:
receiving the detection input of the event corresponding to a third event that is distinguished from the first event and the second event; and
supplying power to the single light source of the light-emitting device according to a third control mode,
wherein the third control mode is a control mode in which the first control mode is combined with the second control mode.
